(19) United States
(12) Patent Application Publication
(10) Pub. No.: US 2011/0133665 A1
(43) Pub. Date: Jun. 9, 2011

(54) LUMINANCE ADJUSTING DEVICE

(76) Inventor: Mei-Yueh Huang, Tainan City (TW)

(21) Appl. No.: 12/634,611

(22) Filed: Dec. 9, 2009

(51) Int. Cl. H05B 41/16

(52) U.S. Cl. 315/287

(57) ABSTRACT

A luminance adjusting device for an illuminator utilizes a circuitry to control the brightness of the illuminator, wherein power is stored in a power storage through a step-down circuit. The illuminator has a preset brightness. The preset brightness is done by the calculating processor to run according to an analyzed data received from a sampling frequency circuit to control a pulse modulator for driving the illuminator to emit light. The power switch is turned off and on again shortly, which triggers the calculating processor to control the pulse modular to drive the illuminator to change the preset brightness, so that the brightness of the illuminator is controlled by the time differentials of the power switch's on and off.

### FIELD OF THE INVENTION

This invention relates to a luminance adjusting device, and more particularly, to an adjusting device which is operated by turning on and off a power switch in conjunction with related circuit members to create a time differential to adjust the brightness of an illuminator.

### BACKGROUND OF THE INVENTION

A conventional luminance adjusting technique uses a variable resistor or an electric switch controller to control the activated amount of illuminating members for adjusting the luminance.

The prior art has a number of shortcomings:

1. Although the variable resistor is able to adjust the luminance of the illuminator continuously, but it doesn't have a memory function to save the preset luminance arrangement. Besides, a special wiring is required for changing the brightness.

2. The electric switch controller is capable of changing the number of illuminating members to vary the brightness, but the operation can only be done by a standard process.

A patent with publication No. 200821555 issued by the PTO of the Republic of China for a “Lighting apparatus with a device for luminance adjustment” has disclosed a device which controls the luminance of a light source composed by at least one LED. The luminance adjusting device is electrically connected with a switch for changing the brightness of the luminance. The switch has a number of modes corresponding to the luminance brightness. A detecting circuit is used to detect the switch modes corresponding to the switch. A memory unit is used to store the brightness data of the lighting source which is corresponding to the detected switch mode of the detecting circuit. The memory unit also transforms the brightness data into a brightness control signal to be sent to the detecting circuit. A power transfer circuit is used to receive the signal from the detecting circuit for controlling the brightness corresponding to the switch mode.

The principle of the prior art of the luminance control is to use multiple LEDs to do a luminance adjustment, by starting the different amount of the LEDs to vary the brightness. It is impossible for the prior art to adjust the luminance by only starting a single LED.

### SUMMARY OF THE INVENTION

This invention is to solve the problems of adjusting the brightness of a single illuminator of prior art.

Up to date, to the best knowledge, the inventor has not found any patent relating to a method enabling changing the luminance of an illuminator device.

According to the present invention, there is provided a luminance adjusting device, comprising:

a control board including a step-down circuit, a pulse modulator, a sampling frequency circuit, a power storage and a calculating processor, the power storage being electrically connected to the step-down circuit, the calculating processor being electrically connected to the pulse modulator, the sampling frequency circuit and the power storage, respectively;

an illuminator electrically connected to the step-down circuit and the pulse modulator of the control board, the illuminator having a preset brightness, the preset brightness being done by the calculating processor to run according to an analyzed data received from the sampling frequency circuit to control the pulse modulator for driving the illuminator to emit light;

a power switch electrically connected to the step-down circuit and the sampling frequency circuit of the control board, when the power switch is turned on, power flowing through the step-down circuit to be saved in the power storage, by turning off the power switch shortly after turning on to create a time differential to be sent to the calculating processor, the calculating processor controlling the pulse modulator to drive the illuminator and to change the preset brightness of the illuminator.

Preferably, the step-down circuit is adapted to transform the local voltage into a driving voltage for the illuminator.

Preferably, the pulse modulator is adapted to adjust frequency and wave length for changing the brightness setting of the illuminator.

Preferably, the sampling frequency circuit is adapted to analyze local voltage frequency.

Preferably, the power storage is adapted to store power and to supply power to the calculating processor when the power switch is turned off.

Preferably, the calculating processor is adapted to memorize the brightness setting of the illuminator.

Preferably, the illuminator is one of a tungsten lamp, a fluorescent lamp and a light emitting diode lamp.

It is the primary object of the present invention to provide a luminance adjusting device of an illuminator, which has a memorizing effect and enables to switch the power switch rapidly so as to vary the luminance of the illuminator.

It is another object of the present invention to provide a luminance adjusting device of an illuminator, which may change the luminance randomly.

It is a further object of the present invention to provide a luminance adjusting device of an illuminator, which is able to run with either a single or multiple illuminators, and is able to adjust the brightness through a power switch and a control board.

### BRIEF DESCRIPTION OF THE DRAWINGS

FIG. 1 is a block diagram of the structure of the present invention;

FIG. 2 is a block diagram showing the changes of the luminance status;

FIG. 3 is a schematic view showing the time interval of the switch being turned on and off;

FIG. 4 is a circuitry showing a tungsten lamp being used as the illuminator of the present invention;

FIG. 5 is a circuitry showing a fluorescent lamp being used as the illuminator of the present invention; and

FIG. 6 is a circuitry showing a LED being used as the illuminator of the present invention.

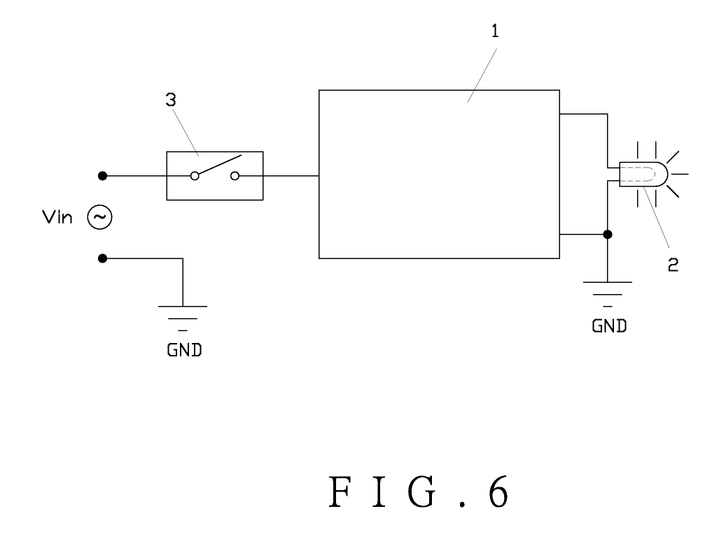

### DETAILED DESCRIPTION OF THE PREFERRED EMBODIMENT

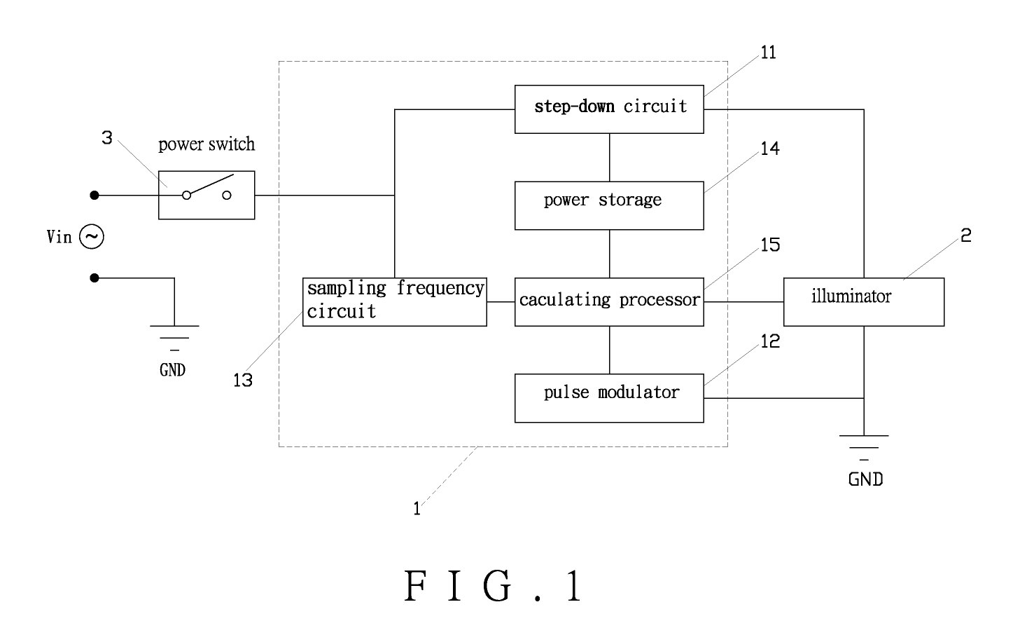

A luminance adjusting device, as shown in FIG. 1, according to a preferred embodiment of the present invention comprises a control board 1, an illuminator 2, and a power switch 3.

The control board 1 includes a step-down circuit 11, a pulse modulator 12, a sampling frequency circuit 13, a power storage 14 and a calculating processor 15. The power storage 14 is electrically connected to the step-down circuit 11, while the calculating processor 15 is electrically connected with the pulse modulator 12, the sampling frequency circuit 13 and the power storage 14, respectively.

The step-down circuit 11 transforms the local voltage into the voltage to drive the illuminator 2.

The pulse modulator 12 adjusts the frequency and the wave width in order to set the brightness of the illuminator 2 either darker or brighter.

The sampling frequency circuit 13 analyzes the variation of the local voltage frequency.

The power storage 14 supplies power to the calculating processor 15 when the power switch 3 is turned off.

The calculating processor 15 memorizes the brightness setting of the illuminator 2 when the power switch 3 is turned on.

The illuminator 2 is electrically connected with the step-down circuit 11 and the pulse modulator 12 of the control board 1. The illuminator 2 has a preset brightness which is done by the calculating processor 15 to run according to an analyzed data received from the sampling frequency circuit 13 to control the pulse modulator 12 for driving the illuminator 2 to emit light;

The power switch 3 is electrically connected with the step-down circuit 11 and the sampling frequency circuit 13 of the control board 1.

When the power switch 3 is turned on, power flows through the step-down circuit 11 and is stored in the power storage 14. When receiving an analyzed data from the sampling frequency circuit 13, the calculating processor 15 controls the pulse modulator 12 to drive the illuminator 2 to generate a preset brightness. By turning off the power switch shortly after turning on to create a time differential to be sent to the calculating processor 15, calculating processor 15 which then drives the pulse modulator 12 to drive the illuminator 2 to change the preset luminance.

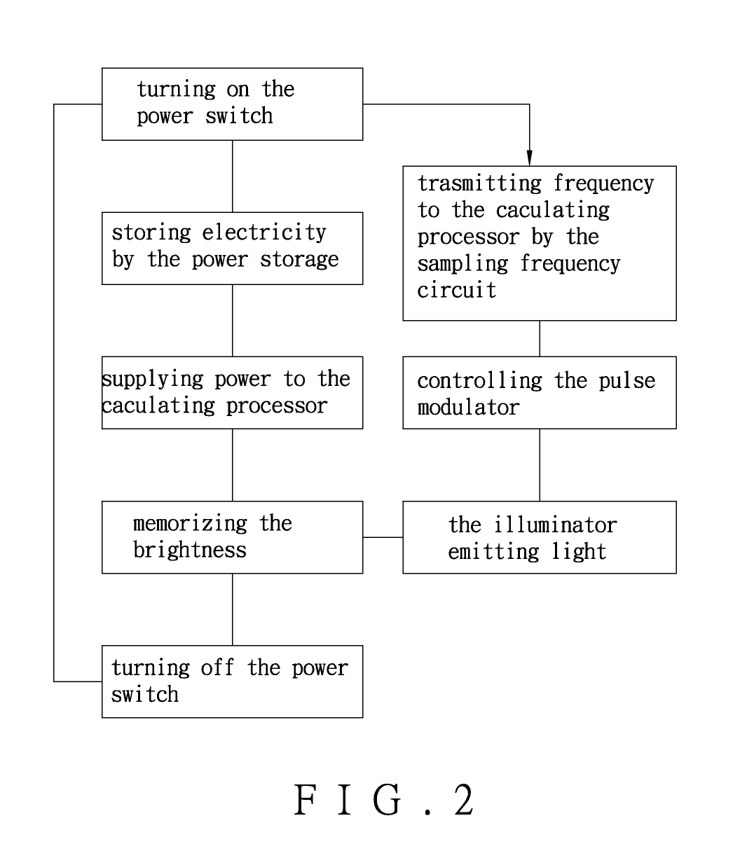

FIGS. 1 and 2 disclose the principle and process of changing the brightness according to the embodiment of the present invention. When the power switch 3 is turned on, power flows through the step-down circuit 11 and is stored in the power storage 14. The calculating processor 15 drives the pulse modulator 12 according to the analyzed data received from the sampling frequency circuit 13 to drive the illuminator 2 to generate a preset brightness. Upon the brightness is set, the power switch 3 is turned off again, and the power storage 14 will supply power to run the calculating processor 15 to memorize the preset brightness of the illuminator 2. When the power switch 3 is turned on again, the calculating processor 15 will control the pulse modulator 12 to drive the illuminator 2 to emit. The brightness of the illuminator 2 will be changed accordingly. The change of the brightness depends upon the interval of the power switch 3′ on and off, and the adjustment of the pulse modulator 12.

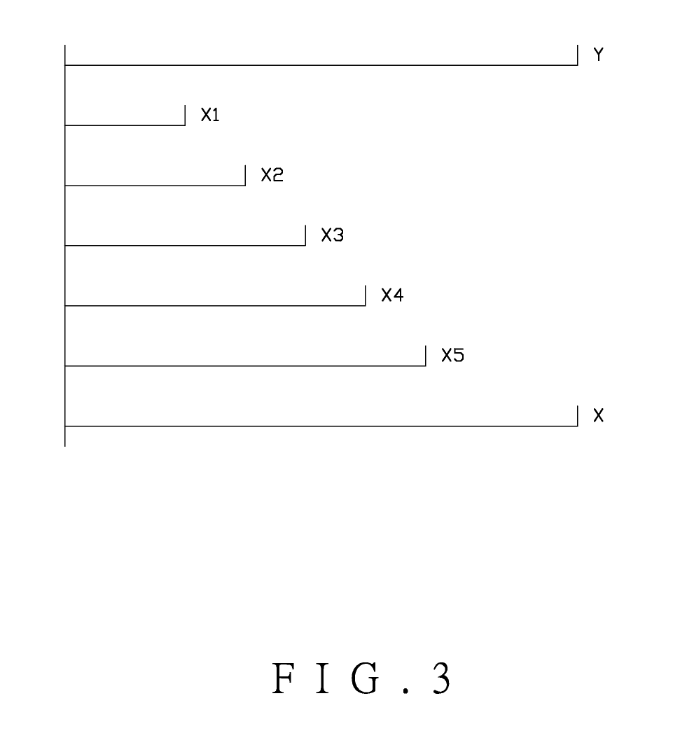

When the power switch 3 is turned off, the power volume stored in the power storage 14 is marked as symbol Y, as shown in FIG. 3, when the power is turned on again, the starting point is set as X, wherein when X is variable and is smaller than Y (X<Y), which means that the starting point is varied, depending upon the interval between the power switch 3's on and off, as shown by the X1, X2, X3, X4, X5, representing different starting points. Different starting points represent different brightness of the illuminator 2. In case of the interval time is larger than symbol Y, upon the power switch 3 is turned on, the calculating processor 15 will recalculate to control the pulse modulator 12 by the analyzed data received from the sampling frequency circuit 13 and to drive the illuminator 2 to emit light so as to reset an initial brightness.

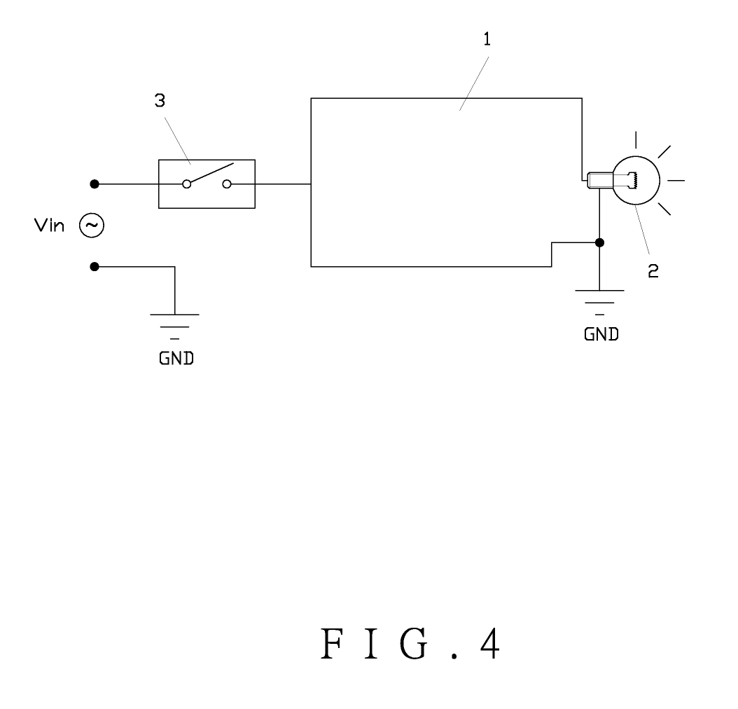

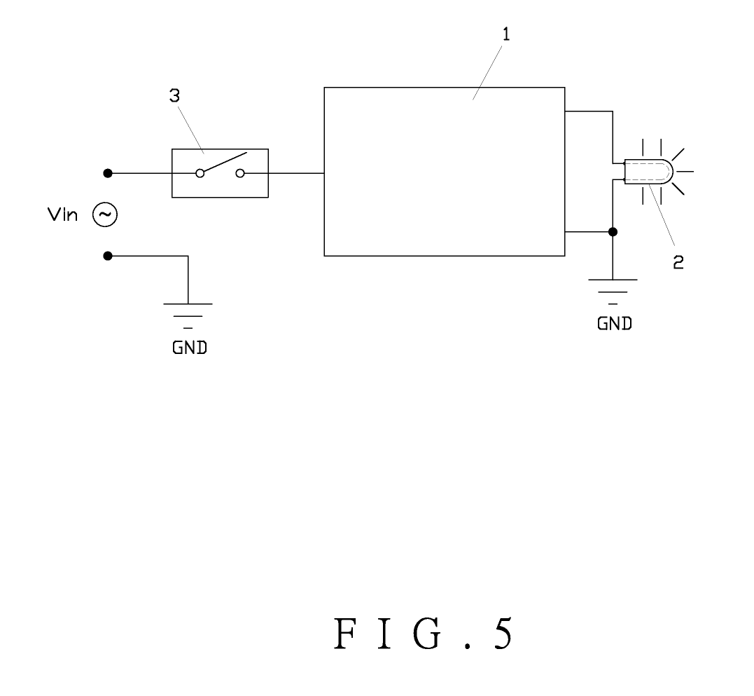

The illuminator 2 can be one of a tungsten lamp, a fluorescent lamp and a LED lamp. As shown in FIGS. 4, 5, a single illuminator 2 is used. No matter it is a tungsten lamp, a fluorescent lamp or a LED lamp, multiple illuminators 2 can also be used for this invention. Each illuminator 2 has its own luminance that is able to turn up the brightness or down.

What is claimed is:

1. A luminance adjusting device, comprising:
a control board including a step-down circuit, a pulse modulator, a sampling frequency circuit, a power storage and a calculating processor, the power storage being electrically connected to the step-down circuit, the calculating processor being electrically connected to the pulse modulator, the sampling frequency circuit and the power storage, respectively;
an illuminator electrically connected to the step-down circuit and the pulse modulator of the control board, the illuminator having a preset brightness, the preset brightness being done by the calculating processor to run according to an analyzed data received from the sampling frequency circuit to control the pulse modulator for driving the illuminator to emit light;
a power switch electrically connected to the step-down circuit and the sampling frequency circuit of the control board, when the power switch is turned on, power flowing through the step-down circuit to be saved in the power storage, by turning off the power switch shortly after turning on to create a time differential to be sent to the calculating processor, the calculating processor controlling the pulse modulator to drive the illuminator and to change the preset brightness of the illuminator.

2. The luminance adjusting device as claimed in claim 1, wherein the step-down circuit is adapted to transform the local voltage into a driving voltage for the illuminator.

3. The luminance adjusting device as claimed in claim 1, wherein the pulse modulator is adapted to adjust frequency and wave length for changing the brightness setting of the illuminator.

4. The luminance adjusting device as claimed in claim 1, wherein the sampling frequency circuit is adapted to analyze local voltage frequency.

5. The luminance adjusting device as claimed in claim 1, wherein the power storage is adapted to store power and to supply power to the calculating processor when the power switch is turned off.

6. The luminance adjusting device as claimed in claim 1, wherein the calculating processor is adapted to memorize the brightness setting of the illuminator.

7. The luminance adjusting device as claimed in claim 1, wherein the illuminator is one of a tungsten lamp, a fluorescent lamp and a light emitting diode lamp.
